(19) United States
(12) Patent Application Publication
(10) Pub. No.: US 2021/0072186 A1
(43) Pub. Date: Mar. 11, 2021

(54) OUTPUT CHECKING DEVICE FOR A WIRE ROPE FLAW DETECTOR

(71) Applicant: Mitsubishi Electric Corporation, Chiyoda-ku, Tokyo (JP)

(72) Inventors: Tetsuya KOIKE, Tokyo (JP); Tomokazu Hoshinoo, Tokyo (JP); Kazuaki Hirota, Tokyo (JP); Fumitake Takahashi, Tokyo (JP); Toyohiro Noguchi, Tokyo (JP); Takashi Yoshioka, Tokyo (JP); Tetsuro Seki, Tokyo (JP)

(73) Assignee: Mitsubishi Electric Corporation, Chiyoda-ku, Tokyo (JP)

(21) Appl. No.: 16/959,544

(22) PCT Filed: Jan. 25, 2019
(86) PCT No.: PCT/JP2019/002407

§ 371 Date: Jul. 1, 2020

(30) Foreign Application Priority Data
Jan. 29, 2018 (JP) 2018-012174

(51) Int. Cl. G01N 27/82

(52) U.S. Cl. CPC G01N 27/82

(57) ABSTRACT

Provided is an output checking device for a wire rope flaw detector, with which the presence or absence of abnormality in an output of a wire rope flaw detector can be more reliably checked. The output checking device for a wire rope flaw detector includes: a pipe; and a test body to be allowed to move inside the pipe. The pipe is placed in a wire rope placement portion of a wire rope flaw detector, through which a wire rope moves when the wire rope flaw detector detects damage of the wire rope. The test body includes: a test piece guide made of a non-magnetic material; and a test piece made of a magnetic material, which is provided to the test piece guide.

### TECHNICAL FIELD

The present invention relates to an output checking device for a wire rope flaw detector, which is configured to examine and check an output of a wire rope flaw detector configured to detect damage of a wire rope.

### BACKGROUND ART

There has hitherto been known an output checking device for a wire rope flaw detector, which includes a pipe having a cylindrical shape and a falling body, which is provided inside the pipe and falls along the pipe. The falling body is formed in a spherical shape. Further, the falling body is made of a magnetic material. The pipe is placed in a portion of a wire rope flaw detector, through which a wire rope runs. The portion of the wire rope flaw detector, through which the wire rope runs, is referred to as a wire rope placement portion. The pipe is placed in the wire rope placement portion under a state of standing with respect to a horizontal plane so that the falling body falls therethrough. The falling body moves inside the pipe under a state in which the pipe is placed in the wire rope placement portion. The wire rope flaw detector includes a magnetic sensor. The wire rope flaw detector outputs a signal based on a magnetic flux detected by the magnetic sensor when the falling body passes by the wire rope placement portion. The presence or absence of abnormality in an output of the wire rope flaw detector is checked based on the signal output from the wire rope flaw detector.

### CITATION LIST

### Patent Literature

[PTL 1] JP 2012-154729 A

### SUMMARY OF INVENTION

### Technical Problem

A magnet is used for the wire rope placement portion of the wire rope flaw detector. Thus, a magnetic force acts between the falling body and the wire rope placement portion. As a result, an attractive force from the wire rope placement portion acts on the falling body. When the attractive force which acts on the falling body is large, the fall of the falling body is interfered. In this case, there arises a problem in that the presence or absence of abnormality in the output of the wire rope flaw detector cannot be checked.

The present invention has been made to solve the problem described above, and has an object to provide an output checking device for a wire rope flaw detector, with which the presence or absence of abnormality in an output of a wire rope flaw detector can be more reliably checked.

### Solution to Problem

According to one embodiment of the present invention, there is provided an output checking device for a wire rope flaw detector, including: a pipe; and a test body to be allowed to move inside the pipe, wherein the pipe is placed in a wire rope placement portion of a wire rope flaw detector, through which a wire rope moves when the wire rope flaw detector detects damage of the wire rope, and wherein the test body includes: a test piece guide made of a non-magnetic material; and a test piece made of a magnetic material, which is provided to the test piece guide.

### Advantageous Effects of Invention

With the output checking device for a wire rope flaw detector according to the embodiment of the present invention, the test body includes the test piece guide made of the non-magnetic material and the test piece made of the magnetic material. As a result, a weight of the test body can be increased without changing a weight of the test piece. Thus, interference of a fall of the test body due to a magnetic force acting between the test body and the wire rope placement portion of the wire rope flaw detector can be suppressed. As a result, the presence or absence of abnormality in an output of the wire rope flaw detector can be more reliably checked.

### BRIEF DESCRIPTION OF DRAWINGS

FIG. 1 is a schematic view for illustrating a side surface of a wire rope flaw detector to which an output checking device for a wire rope flaw detector according to a first embodiment of the present invention is to be applied and a side surface of a wire rope to be checked by the wire rope flaw detector for its damage.

FIG. 2 is a perspective view for illustrating the wire rope flaw detector of FIG. 1.

FIG. 3 is an exploded perspective view for illustrating the wire rope flaw detector of FIG. 2.

FIG. 4 is a perspective view for illustrating the output checking device for a wire rope flaw detector, which is configured to check and examine an output of the wire rope flaw detector of FIG. 1.

FIG. 5 is a perspective view for illustrating a test body of FIG. 4.

FIG. 6 is a longitudinal sectional view for illustrating the test body of FIG. 5.

FIG. 7 is a perspective view for illustrating a movement start position adjusting portion of FIG. 4.

FIG. 8 is a longitudinal sectional view for illustrating the movement start position adjusting portion of FIG. 7.

FIG. 9 is a schematic view for illustrating a side surface under a state in which the wire rope flaw detector is mounted to the output checking device for a wire rope flaw detector of FIG. 4.

FIG. 10 is a flowchart for illustrating a procedure of checking an output of the wire rope flaw detector with use of the output checking device for a wire rope flaw detector of FIG. 4.

FIG. 11 is a perspective view for illustrating a modification example of the output checking device for a wire rope flaw detector of FIG. 4.

FIG. 12 is a perspective view for illustrating a test body in an output checking device for a wire rope flaw detector according to a second embodiment of the present invention.

FIG. 13 is a longitudinal sectional view for illustrating the test body of FIG. 12.

FIG. 14 is a perspective view for illustrating an output checking device for a wire rope flaw detector according to a third embodiment of the present invention.

FIG. 15 is a transverse sectional view for illustrating an outermost magnetic shielding member of FIG. 14.

FIG. 16 is a transverse sectional view for illustrating a case in which a thumbscrew is used as the outermost magnetic shielding member of FIG. 14.

### DESCRIPTION OF EMBODIMENTS

### First Embodiment

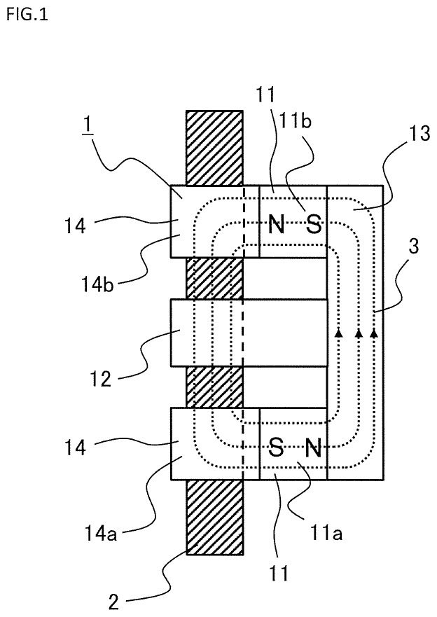

FIG. 1 is a schematic view for illustrating a side surface of a wire rope flaw detector to which an output checking device for a wire rope flaw detector according to a first embodiment of the present invention is to be applied and a side surface of a wire rope to be checked by the wire rope flaw detector for its damage. A wire rope flaw detector 1 is configured to detect damage of a wire rope 2. The wire rope 2 is used for, for example, an elevator or a construction crane. An output checking device for a wire rope flaw detector is configured to examine an output of the wire rope flaw detector 1 and check whether the wire rope flaw detector 1 is normal or abnormal.

Use of the wire rope 2 over a long period of time causes, for example, wear or corrosion in the wire rope 2. As a result, damage such as breakage or disconnection of the wire rope 2 occurs. Thus, the wire rope 2 is regularly replaced. As a method of detecting damage of the wire rope 2, there is given a method of magnetizing one segment of the wire rope 2, which runs at a constant speed in a longitudinal direction of the wire rope 2, with use of a magnet and detecting a magnetic flux leaking from a damaged portion of the wire rope 2. The wire rope flaw detector 1 detects the damage of the wire rope 2 based on the detection of the magnetic flux leaking from the damaged portion.

The wire rope flaw detector 1 includes a pair of permanent magnets 11 provided so as to be apart from each other and a magnetic sensor 12. The pair of permanent magnets 11 are arranged so as to be apart from each other in the longitudinal direction of the wire rope 2. One of the pair of permanent magnets 11 is referred to as a first permanent magnet 11a, and another one thereof is referred to as a second permanent magnet 11b. The magnetic sensor 12 is arranged between the first permanent magnet 11a and the second permanent magnet 11b. The magnetic sensor 12 is configured to detect a leakage magnetic flux generated from a damaged portion of the wire rope 2.

The wire rope flaw detector 1 further includes a back yoke 13 and a pair of pole pieces 14. Each of the pair of permanent magnets 11 is fixed to the back yoke 13. The pair of pole pieces 14 are provided to the pair of permanent magnets 11, respectively. One of the pair of pole pieces 14 is referred to as a first pole piece 14a, and another one thereof is referred to as a second pole piece 14b. The first pole piece 14a is fixed to the first permanent magnet 11a. The second pole piece 14b is fixed to the second permanent magnet 11b. The magnetic sensor 12 is fixed to the back yoke 13.

Each of the back yoke 13, the first pole piece 14a, and the second pole piece 14b is made of a magnetic material.

When the wire rope 2 is mounted to the wire rope flaw detector 1, the first permanent magnet 11a and the second permanent magnet 11b magnetize the wire rope 2. Specifically, the first permanent magnet 11a and the second permanent magnet 11b function as a magnetizer configured to magnetize the wire rope 2. As a result of the magnetization of the wire rope 2, a magnetic loop 3 that passes through the first permanent magnet 11a, the second permanent magnet 11b, the back yoke 13, the first pole piece 14a, the second pole piece 14b, and the wire rope 2 is formed. The magnetizer is not limited to the permanent magnets 11, and electromagnets may be used as the magnetizer.

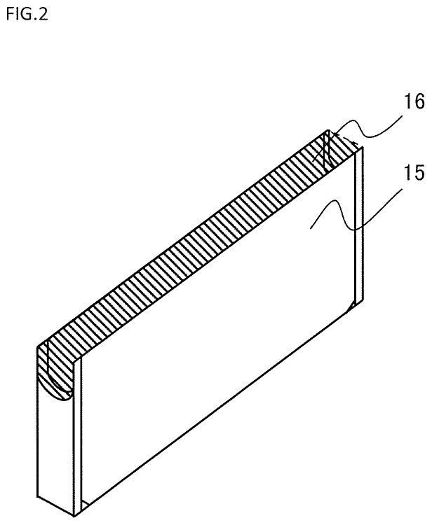

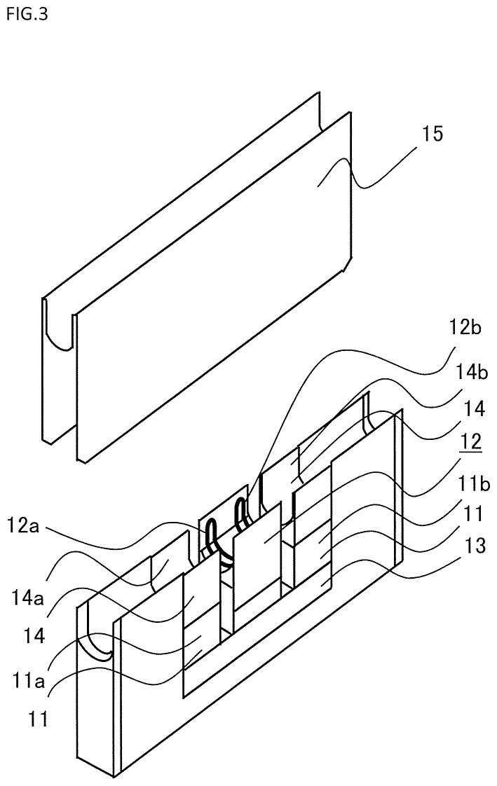

FIG. 2 is a perspective view for illustrating the wire rope flaw detector 1 of FIG. 1. FIG. 3 is an exploded perspective view for illustrating the wire rope flaw detector 1 of FIG. 2. The first permanent magnet 11a and the second permanent magnet 11b are configured to magnetize the wire rope 2. The back yoke 13 connects the first permanent magnet 11a and the second permanent magnet 11b. The first pole piece 14a and the second pole piece 14b are each formed in a U-like shape so as to cause a magnetic flux generated from the first permanent magnet 11a and a magnetic flux generated from the second permanent magnet 11b to efficiently flow into the wire rope 2. At a center between the first pole piece 14a and the second pole piece 14b, the magnetic sensor 12 is arranged. The magnetic sensor 12 includes a first search coil 12a and a second search coil 12b. Each of the first search coil 12a and the second search coil 12b is formed by shaping a coil, which has been wound into an oval shape, into a U-like shape.

The wire rope flaw detector 1 further includes a cover 15 configured to cover the permanent magnets 11, the magnetic sensor 12, and the pole pieces 14. The cover 15 prevents the permanent magnets 11, the magnetic sensor 12, and the pole pieces 14 from being brought into contact with the wire rope 2. Through the prevention of contact, the permanent magnets 11, the magnetic sensor 12, and the pole pieces 14 are protected.

In a portion of the wire rope flaw detector 1, through which the wire rope 2 moves, a U-shaped groove is formed. The U-shaped groove is formed continuously in the pair of pole pieces 14 and the magnetic sensor 12. The wire rope flaw detector 1 is installed so that the wire rope 2 is placed along the U-shaped groove formed in the wire rope flaw detector 1. The portion of the wire rope flaw detector 1, through which the wire rope 2 moves, specifically, the portion of the wire rope flaw detector 1, in which the U-shaped groove is formed and the wire rope 2 is placed, is referred to as a wire rope placement portion 16.

Next, an operation of the wire rope flaw detector 1 is described. First, the wire rope 2 is mounted to the wire rope flaw detector 1 so that the wire rope 2 is placed in the wire rope placement portion 16. The wire rope flaw detector 1 may be mounted to the wire rope 2 so that the wire rope 2 is placed in the wire rope placement portion 16. After that, the wire rope 2 is moved relative to the wire rope flaw detector 1 in the longitudinal direction of the wire rope 2. As a method of moving the wire rope 2 relative to the wire rope flaw detector 1, the wire rope 2 may be moved with respect to the wire rope flaw detector 1, or the wire rope flaw detector 1 may be moved with respect to the wire rope 2.

In the case in which the wire rope 2 is moved relative to the wire rope flaw detector 1, when a portion of the wire rope 2, which passes through the magnetic sensor 12, has a damaged portion, the magnetic sensor 12 detects the leakage magnetic flux generated from the damaged portion of the wire rope 2. A detection signal of the magnetic sensor 12 is input to a terminal device (not shown) connected to the magnetic sensor 12 as an output of the wire rope flaw detector 1. The terminal device includes a determination unit and a display unit. The determination unit is configured to determine the presence or absence of damage in the wire rope 2 based on the output of the wire rope flaw detector 1. The display unit is configured to display a result of the determination made by the determination unit. As the terminal device, there is given, for example, a personal computer.

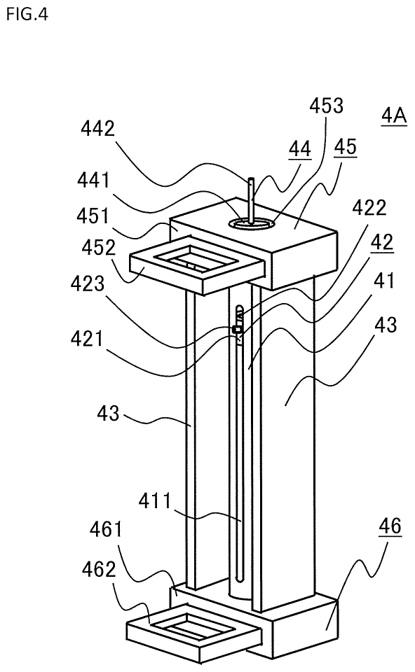

FIG. 4 is a perspective view for illustrating the output checking device for a wire rope flaw detector, which is configured to check and examine the output of the wire rope flaw detector 1 of FIG. 1. An output checking device 4A for a wire rope flaw detector includes a pipe 41 and a test body 42. The test body 42 is provided inside the pipe 41 and falls along a longitudinal direction of the pipe 41. The test body 42 falls to move inside the pipe 41. The output checking device 4A for a wire rope flaw detector further includes a pair of magnetic shielding members 43 and a movement start position adjusting portion 44. The pair of magnetic shielding members 43 are arranged around the pipe 41. The movement start position adjusting portion 44 is provided on top of the pipe 41. The output checking device 4A for a wire rope flaw detector further includes an upper frame 45 and a lower frame 46. The upper frame 45 is provided at an upper part of the pipe 41. The lower frame 46 is provided at a lower part of the pipe 41.

The pipe 41 is formed in a cylindrical shape. The pipe 41 is arranged so as to extend in a direction perpendicular to a horizontal plane, specifically, in a vertical direction. The pipe 41 may be arranged so that the longitudinal direction of the pipe 41 is inclined with respect to the horizontal plane. When the output checking device 4A for a wire rope flaw detector is mounted to the wire rope flaw detector 1, or when the wire rope flaw detector 1 is mounted to the output checking device 4A for a wire rope flaw detector, the pipe 41 is placed in the wire rope placement portion 16 of the wire rope flaw detector 1. An outer-diameter dimension of the pipe 41 is set so as to allow the placement of the pipe 41 in the wire rope placement portion 16 of the wire rope flaw detector 1. In this example, the outer-diameter dimension of the pipe 41 is the same as a diameter dimension of the wire rope 2.

The pipe 41 is made of a non-magnetic material. With use of the non-magnetic material, the pipe 41 is not affected by a magnetic force of the permanent magnets 11 used in the wire rope flaw detector 1. A cutout 411 extending in the longitudinal direction of the pipe 41 is formed in a portion of a side wall of the pipe 41 except for both end portions of the pipe 41 in the longitudinal direction. The cutout 411 passes through the side wall of the pipe 41 in a radial direction of the pipe 41. The longitudinal direction of the pipe 41 matches with a moving direction of the test body 42. The cutout 411 formed in the pipe 41 is formed smooth without burr.

The test body 42 includes a test piece guide 421, a test piece 422, and a tab 423. The test piece guide 421 is provided inside the pipe 41. The test piece 422 is provided at an upper part of the test piece guide 421. The tab 423 is provided to the test piece guide 421.

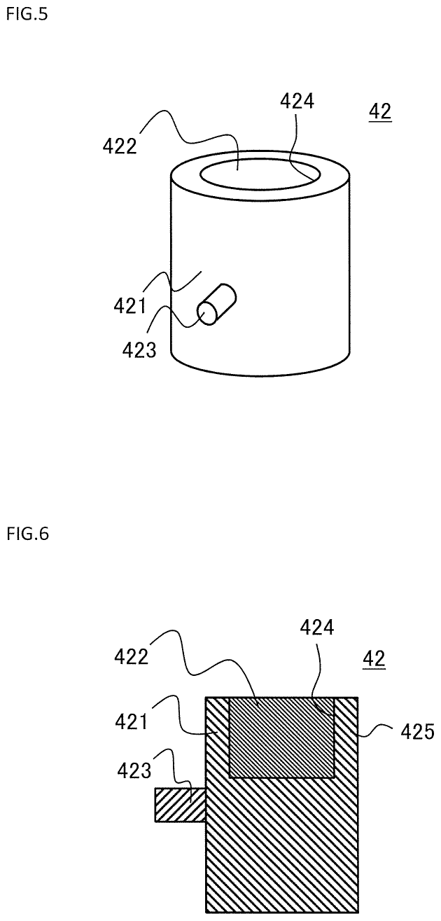

FIG. 5 is a perspective view for illustrating the test body 42 of FIG. 4. FIG. 6 is a longitudinal sectional view for illustrating the test body 42 of FIG. 5. The test piece guide 421 is made of a material having such a degree of stiffness that allows the test body 42 to resist against deformation, which may be caused by an impact at the time of the fall of the test body 42. Further, the test piece guide 421 is made of a non-magnetic material. With use of the non-magnetic material, the test piece guide 421 is not affected by the magnetic force of the permanent magnets 11 used in the wire rope flaw detector 1.

The test piece guide 421 is formed in a columnar shape. Further, a recessed portion 424 having a disc-like shape is formed in an upper surface of the test piece guide 421. An outer peripheral surface of the test piece guide 421 is formed smooth without burr. The outer peripheral surface of the test piece guide 421 is to be brought into contact with an inner peripheral surface of the side wall of the pipe 41. The test piece guide 421 has a side-surface covering portion 425 configured to cover a side surface of the test piece 422.

The test piece 422 is formed in a disc-like shape. The test piece 422 is placed in the recessed portion 424 of the test piece guide 421. The test piece 422 is made of a magnetic material.

The tab 423 is provided on the outer peripheral surface of the test piece guide 421. Further, the tab 423 projects outward from the outer peripheral surface of the test piece guide 421 in a radial direction of the test piece guide 421. Further, the tab 423 extends from the outer peripheral surface of the test piece guide 421 through the cutout 411 to an outside of the pipe 41. A total length of the tab 423 is adjusted to such a length that allows the tab 423 to be caught by fingers of an operator so that the operator can easily pull up the test body 42 with the fingers.

As illustrated in FIG. 4, each of the pair of magnetic shielding members 43 is formed in a plate-like shape. The pipe 41 is placed between the pair of magnetic shielding members 43. When the pipe 41 is placed in the wire rope placement portion 16 of the wire rope flaw detector 1, the magnetic shielding members 43 are located around the wire rope placement portion 16 of the wire rope flaw detector 1. A shape of each of the magnetic shielding members 43 is not limited to the plate-like shape, and may be, for example, a solid round bar shape or a hollow round bar shape. The magnetic shielding members 43 are made of a magnetic material.

The movement start position adjusting portion 44 includes a flange collar 441 and a shaft 442. The flange collar 441 corresponds to a support portion provided to the pipe 41, into which an upper end portion of the pipe 41 is inserted. The shaft 442 corresponds to a movement start position adjusting portion main body, which is provided to the flange collar 441 and is to be brought into contact with an upper surface of the test body 42. The movement start position adjusting portion 44 is made of a non-magnetic material.

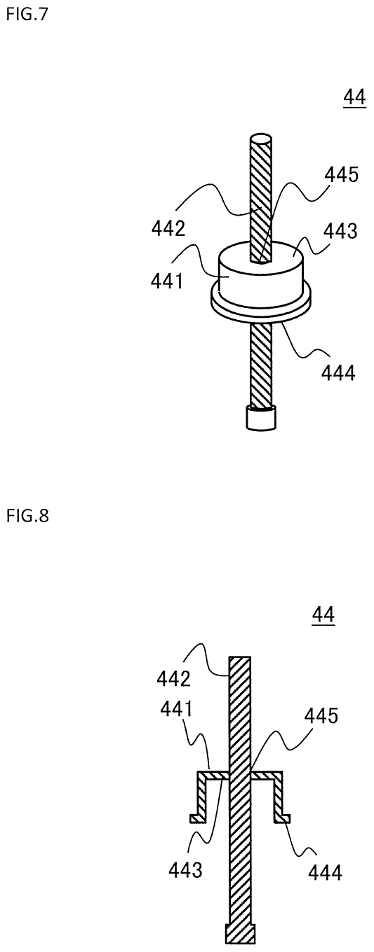

FIG. 7 is a perspective view for illustrating the movement start position adjusting portion 44 of FIG. 4. FIG. 8 is a longitudinal sectional view for illustrating the movement start position adjusting portion 44 of FIG. 7. The shaft 442 is formed in a round bar shape. Thread grooves are formed in an outer peripheral surface of the shaft 442. The shaft 442 may be a bolt.

The flange collar 441 is formed in a brimmed hat-like shape. In other words, the flange collar 441 includes an insertion portion 443 and a flange portion 444. The insertion portion 443 has a columnar shape, and has a lower surface in which a recessed portion is formed. The flange portion 444 is provided at one end of the insertion portion 443 in a longitudinal direction of the insertion portion 443, and projects outward from the insertion portion 443 in a radial direction of the insertion portion 443. An upper end portion of the pipe 41 is inserted into the recessed portion formed in the insertion portion 443 from below. A diameter dimension of the recessed portion formed in the insertion portion 443 is substantially equal to the outer-diameter dimension of the pipe 41. The pipe 41 is fitted into the flange collar 441 by such a degree that the pipe 41 is movable in an axial direction of the pipe 41 with respect to the flange collar 441. A threaded hole 445, into which the shaft 442 is to be inserted, is formed in the flange collar 441. The threaded hole 445 is formed so as to extend in the longitudinal direction of the insertion portion 443. Through rotation of the shaft 442, a position of the shaft 442 with respect to the flange collar 441 changes in the longitudinal direction of the insertion portion 443. In this manner, the position of the shaft 442 can be changed in the moving direction of the test body 42 with respect to the flange collar 441.

As illustrated in FIG. 4, the upper frame 45 includes an upper plate 451 and an upper handle 452 provided to the upper plate 451. The upper frame 45 is made of a non-magnetic material. A through hole 453, into which the flange collar 441 is to be inserted from below, is formed in the upper plate 451. A diameter dimension of the through hole 453 is substantially equal to an outer-diameter dimension of the insertion portion 443 of the flange collar 441. The insertion portion 443 of the flange collar 441 is fitted into the through hole 453 of the upper plate 451 by such a degree that the insertion portion 443 of the flange collar 441 is movable in the axial direction of the pipe 41 with respect to the through hole 453 of the upper plate 451. Further, grooves or holes (not shown), into which the magnetic shielding members 43 are to be mounted from below, are formed in the upper plate 451. The upper handle 452 is provided to the upper plate 451 so that the wire rope placement portion 16 of the wire rope flaw detector 1 is located between the back yoke 13 of the wire rope flaw detector 1 and the upper handle 452 when viewed from above.

The lower frame 46 includes a lower plate 461 and a lower handle 462 provided to the lower plate 461. The lower frame 46 is made of a non-magnetic material. A groove (not shown), into which a lower end portion of the pipe 41 is to be mounted, is formed in the lower plate 461. Further, grooves (not shown), into which the magnetic shielding members 43 are to be mounted, are formed in the lower plate 461. A shock absorber may be provided in the groove of the lower plate 461, into which the lower end portion of the pipe 41 is to be mounted. The lower handle 462 is provided to the lower plate 461 so that the wire rope placement portion 16 of the wire rope flaw detector 1 is located between the back yoke 13 of the wire rope flaw detector 1 and the lower handle 462 when viewed from above.

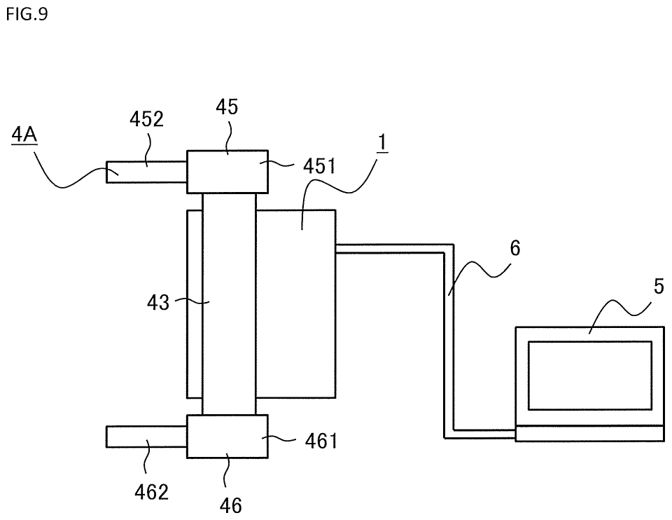

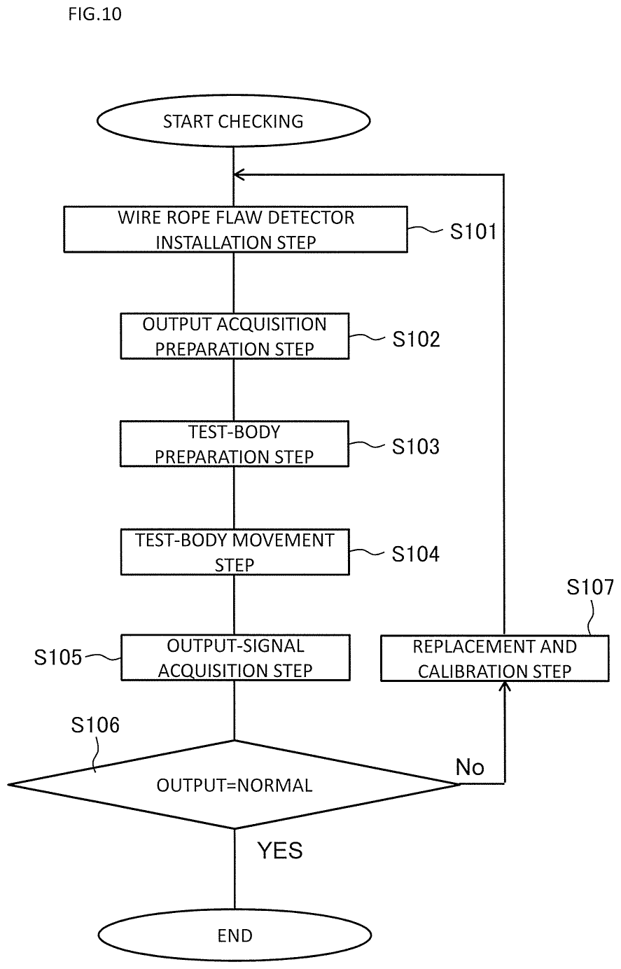

Next, a procedure of examining and checking the output of the wire rope flaw detector 1 with use of the output checking device 4A for a wire rope flaw detector is described. FIG. 9 is a schematic view for illustrating a side surface under a state in which the wire rope flaw detector 1 is mounted to the output checking device 4A for a wire rope flaw detector of FIG. 4. FIG. 10 is a flowchart for illustrating a procedure of checking the output of the wire rope flaw detector 1 with use of the output checking device 4A for a wire rope flaw detector of FIG. 4. In FIG. 9, a terminal device 5 and a cable 6 are further illustrated. The terminal device 5 is configured to receive the output of the wire rope flaw detector 1 to be input thereto. The cable 6 is configured to connect the wire rope flaw detector 1 and the terminal device 5 to each other.

First, in Step S101, a wire rope flaw detector installation step is carried out. In the wire rope flaw detector installation step, the wire rope flaw detector 1 is assembled. Further, the wire rope flaw detector 1 and the terminal device 5 are electrically connected to each other with use of the cable 6. Further, in the wire rope flaw detector installation step, the wire rope flaw detector 1 is mounted to the output checking device 4A for a wire rope flaw detector, or the output checking device 4A for a wire rope flaw detector is mounted to the wire rope flaw detector 1. In this manner, the pipe 41 is placed in the wire rope placement portion 16 of the wire rope flaw detector 1. At this time, the output checking device 4A for a wire rope flaw detector is arranged so that the pipe 41 extends in the direction perpendicular to the horizontal plane. At this time, the flange collar 441 is pushed down to bring a lower surface of the flange collar 441 into contact with an upper surface of the wire rope flaw detector 1.

After that, in Step S102, an output acquisition preparation step is carried out. In the output acquisition preparation step, the terminal device 5 is operated so as to achieve a state in which the output of the wire rope flaw detector 1 can be acquired by the terminal device 5.

After that, in Step S103, a test-body preparation step is carried out. In the test-body preparation step, the operator pulls up the tab 423 of the test body 42 with fingers to slide the test body 42 upward with respect to the pipe 41. Further, in the moving-body preparation step, the upper surface of the test body 42 is brought into contact with a lower surface of the shaft 442 of the movement start position adjusting portion 44. At this time, it is confirmed that the lower surface of the flange collar 441 is in contact with the upper surface of the wire rope flaw detector 1.

After that, in Step S104, a test-body movement step is carried out. In the test-body movement step, the operator releases the fingers from the tab 423 of the test body 42. As a result, the test body 42 falls along the pipe 41.

After that, in Step S105, an output-signal acquisition step is carried out. In the output-signal acquisition step, a detection signal, which is output from the magnetic sensor 12 when the test body 42 passes by the magnetic sensor 12 of the wire rope flaw detector 1, is acquired by the terminal device 5 as an output of the wire rope flaw detector 1.

After that, in Step S106, an abnormality presence/absence determination step is carried out. In the abnormality presence/absence determination step, the terminal device 5 compares the acquired output of the wire rope flaw detector 1 and an output of the wire rope flaw detector 1, which has been measured in advance and has been checked when the wire rope flaw detector 1 is normal, with each other, to thereby determine whether or not the wire rope flaw detector 1 is normal.

When it is determined in Step S106 that the wire rope flaw detector 1 is not normal, a replacement and calibration step is carried out in Step S107. In the replacement and calibration step, a component of the magnetic sensor 12 is replaced, or the magnetic sensor 12 is calibrated. After that, the procedure returns to Step S101.

Meanwhile, when it is determined in Step S106 that the wire rope flaw detector 1 is normal, the procedure of examining the output of the wire rope flaw detector 1 and checking whether the wire rope flaw detector 1 is normal or abnormal is terminated. After that, the wire rope 2 is inspected with use of the wire rope flaw detector 1.

As described above, with the output checking device 4A for a wire rope flaw detector according to the first embodiment of the present invention, the test body 42 includes the test piece guide 421 made of a non-magnetic material and the test piece 422 made of a magnetic material. With the configuration described above, a weight of the test body 42 can be adjusted so that the test body 42 can fall without being interfered by an attractive force of the permanent magnets 11 used in the wire rope flaw detector 1, which acts on the test body 42. For example, when a magnetic force of the permanent magnets 11 used in the wire rope flaw detector 1 is strong and the attractive force which acts on the test body 42 is large, the test piece guide 421 is replaced by another one that has a weight required to allow the test body 42 to fall. As a result, the test body 42 can fall smoothly.

Further, the test piece guide 421 has the side-surface covering portion 425 provided on the side surface of the test piece 422. With the side-surface covering portion 425, wear of the test piece 422 due to friction between the test body 42 and the pipe 41 can be prevented. As a result, a fluctuation in output of the wire rope flaw detector 1 due to degradation of the test piece 422 can be prevented.

Further, the cutout 411 extending in the moving direction of the test piece 422 is formed in the side wall of the pipe 41. With the cutout 411, when the test body 42 falls, air that is present below the test body 42 inside the pipe 41 is discharged through the cutout 411. As a result, an influence of an air pressure on the test body 42 is reduced. In this manner, the test body 42 can fall smoothly.

Further, the test body 42 has the tab 423 extending from the test piece guide 421 through the cutout 411 to the outside of the pipe 41. With the tab 423, the operator can easily pull up the test body 42.

Further, the magnetic shielding members 43 made of a magnetic material are provided around the wire rope placement portion 16 of the wire rope flaw detector 1. In other words, the magnetic shielding members 43 are arranged outside the wire rope placement portion 16 of the wire rope flaw detector 1. With the magnetic shielding members 43, magnetism from the outside can be prevented from reaching the wire rope flaw detector 1. As a result, variation in output of the output checking device 4A for a wire rope flaw detector, which may occur depending on a location of measurement, can be suppressed.

Further, the movement start position adjusting portion 44 is provided inside the pipe 41. The test body 42 starts falling under a state in which the lower surface of the shaft 442 of the movement start position adjusting portion 44 and the upper surface of the test body 42 are in contact with each other. In this manner, variation in distance between the test body 42 and the magnetic sensor 12 for each measurement at the time of start of movement of the test body 42 can be suppressed. As a result, variation in output of the wire rope flaw detector 1 for each measurement, which is input to the terminal device 5, can be suppressed.

Further, the movement start position adjusting portion 44 includes the flange collar 441 and the shaft 442. The flange collar 441 is configured to receive the pipe 41 to be inserted thereinto, and is provided to the pipe 41. The shaft 442 is provided to the flange collar 441, and is to be brought into abutment against the upper surface of the test body 42. The position of the shaft 442 in the moving direction of the test body 42 with respect to the flange collar 441 can be changed. In this manner, the position of the test body 42 at the time of start of movement of the test body 42 can be freely set.

Further, for the flange collar 441 of the movement start position adjusting portion 44, the pipe 41 is movable in the axial direction of the pipe 41 with respect to the flange collar 441. In this manner, the position of the test body 42 at the time of start of the movement of the test body 42 can be set under a state in which the upper surface of the wire rope flaw detector 1 is in contact with the lower surface of the flange collar 441. Thus, the upper surface of the wire rope flaw detector 1 serves as a reference of a movement start position of the test body 42. With the above-mentioned reference of the movement start position, the movement start position of the test body 42 can be fixed regardless of an error of a mounting position of the wire rope flaw detector 1 in the axial direction of the pipe 41, which may occur when the wire rope flaw detector 1 is mounted to the output checking device 4A for a wire rope flaw detector. As a result, variation in measurement results for each measurement can be suppressed.

Further, the test body 42 is arranged inside the pipe 41. Further, the lower end of the pipe 41 is closed by the lower frame 46. With the lower frame 46, when the test body 42 is allowed to fall, the test body 42 is prevented from falling beyond the pipe 41. Thus, the operator is not required to capture the falling test body 42 with a hand. As a result, the operator can perform output checking work for the wire rope flaw detector 1 only with one hand.

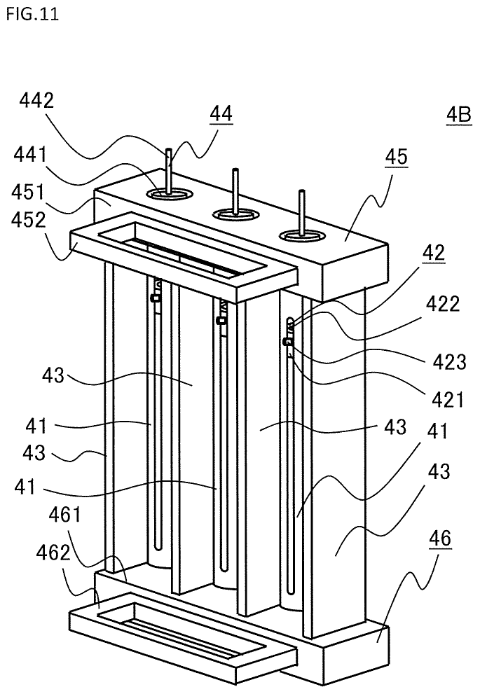

In the first embodiment described above, there has been described the output checking device 4A for a wire rope flaw detector, which includes one pipe 41, one test body 42, and one movement start position adjusting portion 44. Meanwhile, as illustrated in FIG. 11, an output checking device 4B for a wire rope flaw detector, which includes a plurality of pipes 41, a plurality of test bodies 42, and a plurality of movement start position adjusting portions 44, may also be used. In this case, the plurality of pipes 41 are arranged at intervals and in parallel to each other. Further, in this case, the plurality of test bodies 42 are arranged in the plurality of pipes 41, respectively. Further, in this case, the magnetic shielding members 43 are also arranged between the pipes 41 adjacent to each other. With the arrangement described above, the magnetic shielding members 43 are arranged around the wire rope placement portions 16 of the plurality of wire rope flaw detectors 1 so as to separate the wire rope placement portions 16 from each other. Thus, mutual influences of the wire rope placement portions 16 of the wire rope flaw detectors 1 adjacent to each other can be suppressed. In addition, the outputs of the wire rope flaw detectors 1 can be checked at the same time. In this case, in particular, the output checking device 4B for a wire rope flaw detector can be used to check the outputs of the wire rope flaw detectors 1 that detect damage of the plurality of wire ropes adjacent to each other in an elevator at the same time.

### Second Embodiment

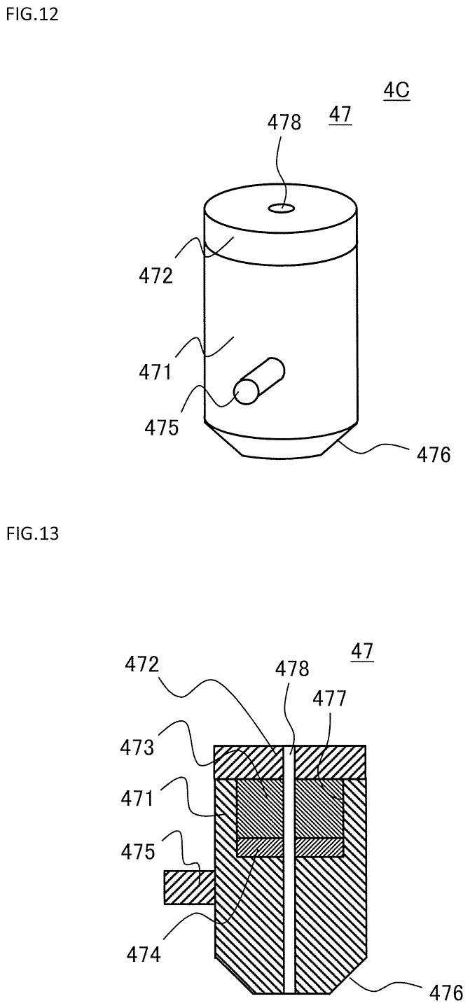

FIG. 12 is a perspective view for illustrating a test body in an output checking device for a wire rope flaw detector according to a second embodiment of the present invention. FIG. 13 is a longitudinal sectional view for illustrating the test body of FIG. 12. An output checking device 4C for a wire rope flaw detector according to the second embodiment is different from the output checking device 4A for a wire rope flaw detector according to the first embodiment in a configuration of a test body 47.

The test body 47 includes a test piece guide lower portion 471, a test piece guide upper portion 472, and a test piece 473. The test piece guide upper portion 472 is provided at an upper part of the test piece guide lower portion 471. The test piece 473 is provided inside the test piece guide lower portion 471. The test body 47 further includes a test-piece spacer 474 and a tab 475. The test-piece spacer 474 is provided inside the test piece guide lower portion 471. The tab 475 is provided to the test piece guide lower portion 471.

A lower end portion of the test piece guide lower portion 471 corresponds to a lower end portion of the test body 47. The test piece guide lower portion 471 is formed in a cylindrical shape. Further, an inclined surface 476 having a dimension in a width direction of the test body 47, which decreases in a downward direction, is formed on a side surface of the lower end portion of the test piece guide lower portion 471. A recessed portion 477 having a disc-like shape is formed in an upper surface of the test piece guide lower portion 471. The test piece guide lower portion 471 is made of a non-magnetic material. Further, the test piece guide lower portion 471 is made of a material having such a degree of stiffness that allows the test body 47 to resist against deformation, which may be caused by an impact at the time of the fall of the test body 47.

The test piece guide upper portion 472 is formed in a disc-like shape. The test piece guide upper portion 472 is arranged so as to cover the recessed portion 477 of the test piece guide lower portion 471 from above. The test piece guide upper portion 472 is made of a non-magnetic material.

The test piece 473 is formed in a disc-like shape. The test piece 473 is placed in the recessed portion 477 of the test piece guide lower portion 471. The test piece 473 is made of a magnetic material.

The test-piece spacer 474 is formed in a disc-like shape. The test-piece spacer 474 is arranged in the recessed portion 477 of the test piece guide lower portion 471. The test-piece spacer 474 is superposed on the test piece 473. The test-piece spacer 474 is made of a non-magnetic material.

The tab 475 is provided on an outer peripheral surface of the test piece guide lower portion 471. The tab 475 projects outward from the outer peripheral surface of the test piece guide lower portion 471 in a radial direction of the test piece guide lower portion 471. The tab 475 extends from the outer peripheral surface of the test piece guide lower portion 471 through the cutout 411 to the outside of the pipe 41. A total length of the tab 475 is adjusted to such a length that allows the tab 475 to be caught by fingers of an operator so that the operator can easily pull up the test body 47 with the fingers.

A through hole 478 extending in a moving direction of the test body 47 is formed through each of the test piece guide lower portion 471, the test piece guide upper portion 472, the test piece 473, and the test-piece spacer 474. In other words, the through hole 478 extending in the moving direction of the test body 47 is formed through the test body 47. Other configurations are the same as those of the first embodiment. Further, a procedure of checking the output of the wire rope flaw detector 1 with use of the output checking device 4C for a wire rope flaw detector is the same as that of the first embodiment.

As described above, with the output checking device 4C for a wire rope flaw detector according to the second embodiment of the present invention, the through hole 478 extending in the moving direction of the test body 47 is formed through the test body 47. With the through hole 478, when the test body 47 moves, air flows through the through hole 478. Thus, the test body 47 can smoothly move. As a result, variation in detection signal output from the wire rope flaw detector 1 can be suppressed.

Further, the inclined surface 476 having the dimension in the width direction of the test body 47, which decreases in the downward direction, is formed on the side surface of the lower end portion of the test piece guide lower portion 471. With the inclined surface 476, air resistance, which acts on the test body 47 when the test body 47 moves, can be reduced. Thus, the test body 47 can fall smoothly. As a result, variation in detection signal output from the wire rope flaw detector 1 can be suppressed.

Further, the test piece 473 and the test-piece spacer 474 are superposed on each other and are arranged in the recessed portion 477 of the test piece guide lower portion 471. With the arrangement described above, a weight of the test body 47 can easily be adjusted by adjusting each of a dimension of the test piece 473 in a thickness direction thereof and a dimension of the test-piece spacer 474 in a thickness direction thereof. In this case, the adjustment is performed so as not to change a sum of the dimension of the test piece 473 in the thickness direction and the dimension of the test-piece spacer 474 in the thickness direction.

Further, a force in the moving direction of the test body 47, which acts on the test body 47, can be adjusted by changing a dimension of the test piece guide upper portion 472 in a thickness direction thereof. With the adjustment of the force in the moving direction, a force in a falling direction, which is required for the test body 47 to fall, can easily be adjusted against an attractive force of the permanent magnets 11 used in the wire rope flaw detector 1, which acts on the test body 47.

### Third Embodiment

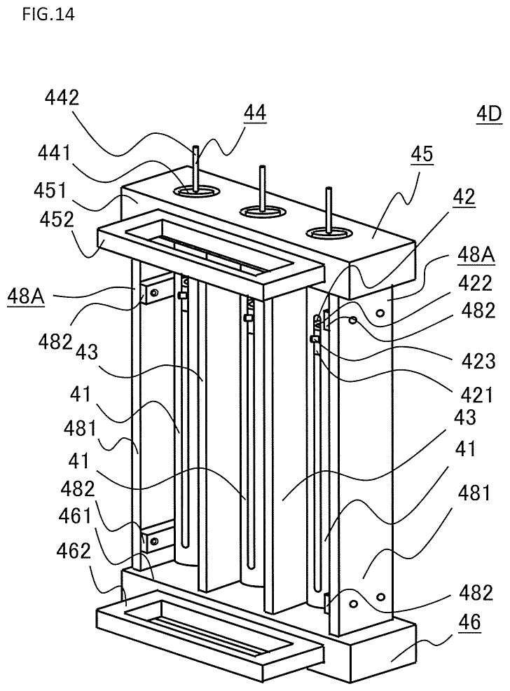

FIG. 14 is a perspective view for illustrating an output checking device for a wire rope flaw detector according to a third embodiment of the present invention. An output checking device 4D for a wire rope flaw detector according to the third embodiment is different from those of the first embodiment and the second embodiment in the configurations of, among a plurality of magnetic shielding members 43 arranged therein, a pair of magnetic shielding members 43, which are located on outermost sides in a direction of arrangement of the plurality of magnetic shielding members 43. The pair of magnetic shielding members 43, which are located on the outermost sides in the direction of arrangement, are referred to as outermost magnetic shielding members 48A.

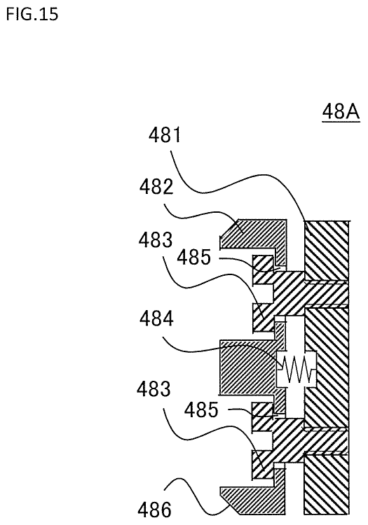

FIG. 15 is a transverse sectional view for illustrating the outermost magnetic shielding member 48A of FIG. 14. The outermost magnetic shielding member 48A includes a magnetic shielding plate 481 and spacers 482 provided so as to be opposed to the magnetic shielding plate 481. The outermost magnetic shielding member 48A further includes stepped bolts 483 and springs 484. The stepped bolts 483 are provided through the magnetic shielding plate 481 and the spacer 482. The spring 484 is provided between the magnetic shielding plate 481 and the spacer 482.

The magnetic shielding plate 481 is made of a magnetic material. The magnetic shielding plate 481 is formed in a plate-like shape.

The spacer 482 is made of a non-magnetic material. The spacer 482 is formed in a plate-like shape. Counterbored holes 485 are formed in the spacer 482. The stepped bolts 483 are inserted into the counterbored holes 485, respectively. The spacer 482 is mounted to the magnetic shielding plate 481 with use of the stepped bolts 483. The spacer 482 is movable in an axial direction of the stepped bolts 483 with respect to the magnetic shielding plate 481. The spacers 482 are provided at an upper part and a lower part of the magnetic shielding plate 481. Such inclined surfaces 486 that allow the wire rope flaw detector 1 to be smoothly inserted in a direction of insertion of the wire rope flaw detector 1 are formed on each of the spacers 482.

The stepped bolts 483 are made of a non-magnetic material. The stepped bolts 483 are selected so that, when the spacer 482 is moved to be brought into contact with the magnetic shielding plate 481, head portions of the stepped bolts 483 do not project beyond a surface of the spacer 482, which is on a side opposite to the magnetic shielding plate 481.

The spring 484 is made of a non-magnetic material. The spring 484 is arranged between the magnetic shielding plate 481 and the spacer 482. The spring 484 serves as a force applying member, which is configured to press the spacer 482 toward the wire rope flaw detector 1 when the pipe is placed in the wire rope placement portion 16.

When the output checking device 4D for a wire rope flaw detector is mounted to the wire rope flaw detector 1, the spacers 482 of each of the outermost magnetic shielding members 48A are located between the pipe 41 and the magnetic shielding plate 481.

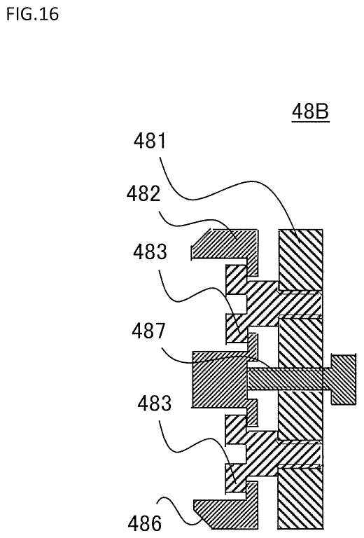

As in an outermost magnetic shielding member 48B illustrated in FIG. 16, a thumbscrew 487 may be provided in place of the spring 484. The thumbscrew 487 passes through the magnetic shielding plate 481 in an axial direction of the stepped bolt 483. The thumbscrew 487 is made of a non-magnetic material.

In FIG. 15 and FIG. 16, other configurations are the same as those of the first embodiment and the second embodiment. Further, a procedure of checking the output of the wire rope flaw detector 1 with use of the output checking device 4D for a wire rope flaw detector is the same as that of the first embodiment or that of the second embodiment. In the third embodiment, in Step S101, when the wire rope flaw detector 1 is mounted to the output checking device 4D for a wire rope flaw detector, the thumbscrews 487 are tightened to press the wire rope flaw detector 1 through the spacers 482.

As described above, with the output checking device 4D for a wire rope flaw detector according to the third embodiment of the present invention, when the pipe 41 is placed in the wire rope placement portion 16, the spacers 482 are located between the pipe 41 and each of the magnetic shielding plates 481. With the presence of the spacers 482, contact of the wire rope flaw detector 1 with the magnetic shielding plate 481 is prevented. As a result, reduction in accuracy of the detection signal of the output checking device 4D for a wire rope flaw detector can be suppressed.

Further, when the pipe 41 is placed in the wire rope placement portion 16, the spacers 482 are pressed toward the pipe 41. In this manner, a force against an attractive force generated by a magnetic force acting in a direction from the wire rope flaw detector 1 toward the outermost magnetic shielding member 48A can be applied to the wire rope flaw detector 1. Thus, variation in mounting position of the wire rope flaw detector 1 is reduced. As a result, occurrence of variation in output of the detection signal of the output checking device 4D for a wire rope flaw detector can be suppressed.

### REFERENCE SIGNS LIST

1 wire rope flaw detector, 2 wire rope, 3 magnetic loop, 4A, 4B, 4C, 4D output checking device for wire rope flaw detector, 5 terminal device, 6 cable, 11 permanent magnet, 11a first permanent magnet, 11b second permanent magnet, 12 magnetic sensor, 12a first search coil, 12b second search coil, 13 back yoke, 14 pole piece, 14a first pole piece, 14b second pole piece, 15 cover, 16 wire rope placement portion, 41 pipe, 42 test body, 43 magnetic shielding member, 44 movement start position adjusting portion, 45 upper frame, 46 lower frame, 47 test body, 48A, 48B outermost magnetic shielding member, 411 cutout, 421 test piece guide, 422 test piece, 423 tab, 424 recessed portion, 425 side-surface covering portion, 441 flange collar, 442 shaft, 443 insertion portion, 444 flange portion, 445 threaded hole, 451 upper plate, 452 upper handle, 453 through hole, 461 lower plate, 462 lower handle, 471 test piece guide lower portion, 472 test piece guide upper portion, 473 test piece, 474 test-piece spacer, 475 tab, 476 inclined surface, 477 recessed portion, 478 through hole, 481 magnetic shielding plate, 482 spacer, 483 stepped bolt, 484 spring, 485 counterbored hole, 486 inclined surface, 487 thumbscrew

1. An output checking device for a wire rope flaw detector, comprising:
a pipe; and
a test body to be allowed to move inside the pipe,
wherein the pipe is placed in a wire rope placement portion of a wire rope flaw detector, when the wire rope flaw detector detects damage of the wire rope, and
wherein the test body includes:
a test piece guide made of a non-magnetic material; and
a test piece made of a magnetic material, which is provided to the test piece guide.

2. The output checking device for a wire rope flaw detector according to claim 1, wherein the test piece guide has a side-surface covering portion configured to cover a side surface of the test piece.

3. The output checking device for a wire rope flaw detector according to claim 1, wherein the test body has a through hole extending in a moving direction of the test body.

4. The output checking device for a wire rope flaw detector according to claim 1, wherein the test body has an inclined surface having a dimension of the test body in a width direction of the test body, which decreases in a downward direction, on a side surface of a lower end portion of the test body.

5. The output checking device for a wire rope flaw detector according to claim 1, wherein the test body further includes a test-piece spacer to be superposed on the test piece.

6. The output checking device for a wire rope flaw detector according to claim 1, wherein a cutout extending in a moving direction of the test body is formed in a side wall of the pipe.

7. The output checking device for a wire rope flaw detector according to claim 6, wherein the test body further includes a tab extending from the test piece guide through the cutout to an outside of the pipe.

8. The output checking device for a wire rope flaw detector according to claim 1, further comprising a magnetic shielding member made of a magnetic material, which is provided around the pipe,
wherein, when the pipe is placed in the wire rope placement portion, the magnetic shielding member is located around the wire rope placement portion.

9. The output checking device for a wire rope flaw detector according to claim 8,
wherein the test body comprises a plurality of test bodies to be provided to a plurality of the pipes arranged at intervals and in parallel to each other, respectively, and
wherein the magnetic shielding member is arranged between the pipes adjacent to each other.

10. The output checking device for a wire rope flaw detector according to claim 8,
wherein the magnetic shield member includes:
a magnetic shielding plate made of a magnetic material; and
a spacer made of a non-magnetic material, which is provided between the wire rope flaw detector and the magnetic shielding plate when the pipe is placed in the wire rope placement portion.

11. The output checking device for a wire rope flaw detector according to claim 10, wherein the magnetic shielding member further includes force applying member, which is configured to press the spacer toward the wire rope flaw detector when the pipe is placed in the wire rope placement portion.

12. The output checking device for a wire rope flaw detector according to claim 1, further comprising a movement start position adjusting portion provided to the pipe,
wherein the test body is configured to start moving from a position at which an upper surface of the test body is brought into abutment against a lower surface of the movement start position adjusting portion.

13. The output checking device for a wire rope flaw detector according to claim 12, wherein the movement start position adjusting portion includes:
a support portion provided to the pipe; and
a movement start position adjusting portion main body, which is provided to the support portion, and is to be brought into abutment against the upper surface of the test body, and
wherein a position of the movement start position adjusting portion main body in a moving direction of the test body with respect to the support portion is changeable.

14. The output checking device for a wire rope flaw detector according to claim 13, wherein the pipe is movable in an axial direction of the pipe with respect to the support portion, and
wherein a lower surface of the support portion is to be brought into contact with an upper surface of the wire rope flaw detector.
